(19) United States
(12) Patent Application Publication
(10) Pub. No.: US 2019/0080349 A1
(43) Pub. Date: Mar. 14, 2019

(54) Device, System, and Method for a Post Benchmark and Projection

(71) Applicant: Viacom International Inc., New York, NY (US)

(72) Inventors: David BERZIN, New York, NY (US); Sashi MARELLA, New York, NY (US); Tanmay MANOHAR, New York, NY (US)

(21) Appl. No.: 15/703,622

(22) Filed: Sep. 13, 2017

(51) Int. Cl. G06Q 30/02; G06F 17/30; G06Q 10/06

(52) U.S. Cl. CPC G06Q 30/0244; G06F 17/30876; G06Q 10/107; G06Q 10/06; G06F 17/30867

(57) ABSTRACT

A device, system, and method generates a post benchmark. The method performed at a comparison server includes receiving data of a past post, the past post having been used for a media content, the past post having known results of reaching an audience. The method includes determining at least one first characteristic of the past post based on at least one entity involved in the past post and the media content. The method includes determining a first similarity index of the at least one first characteristic to at least one second characteristic of a post benchmark, the post benchmark having aggregated results associated therewith. The method includes when the similarity index is above a first threshold, incorporating the past post with the post benchmark, the known results being aggregated with the aggregated results.

### BACKGROUND INFORMATION

A media content post (e.g., a campaign to promote a select media content) may involve a plurality of different entities. For example, the media content may be an upcoming television program. In a television program, a producer producing the program and/or a distributor distributing the program may be a first entity. An advertiser that includes advertisements in the program or that sponsors the program may be a second entity. Further types of entities that may be involved include a social networking entity, an online personality (e.g., a user having a minimum social popularity or influence), a celebrity entity, etc.

To optimize how the combination of entities reach a greatest audience for the media content, a random combination of these entities should not be used as the results of using such a combination may have unpredictable results. Instead, the combination to be considered should be analyzed at a granular level for each selected entity in a combination to determine expected results from using the combination of entities for a selected media content. However, an analysis based on the entity at an individual level for consideration in a combination may require complex processes and operations that may be time consuming and may also not be reliable as assumptions and speculations may be required.

The media content post that may be used in a campaign may be implemented in a variety of manners. With a presence on social media and various outlets across different social media platforms, a post may be seen by a plurality of users of the social media platforms. However, in a substantially similar manner as how a random combination of entities may have unpredictable results, selecting a random social media platform or random outlet in a selected social media platform may have unpredictable results as to how the post performs. As social media, the corresponding platforms, and the use of virtual avenues of reaching users are relatively new in advertising a media content, an analysis that further incorporates how posts perform in combination with selected entities may be unavailable.

### SUMMARY

The exemplary embodiments enable comparisons of social media posts and/or campaigns against other social media posts and/or campaigns with similar characteristics with the goal of benchmarking post performance against historic averages of similar social media posts, as well as predicting future performance of social media posts with a given set of characteristics.

According to the exemplary embodiments, post-level social data across branded campaigns may be ingested to extract detailed metadata about the social media post, an associated audience, and a surrounding context. The content of the social media post may be categorized and classified using a manual approach and/or an automated approach (e.g., via machine learning). The social media post which has been enriched post may then be analyzed in various ways to uncover insights about which characteristics make for social media posts with stronger performance (e.g., impressions, engagement, virality, etc.). The exemplary embodiments may be configured so that a social media post may be given a score (such as a benchmark) against similar social media posts based on a business need (e.g., a first post may have over performed when compared to similar, comedic, short form, branded content, video posts for the auto industry containing grade A social influencers).

Furthermore, in addition to providing post/campaign performance averages for posts/campaigns with similar characteristics, the exemplary embodiments may also enable social media post/campaign expected performance range predictions to be determined based on a selection of characteristics and current performance trends. The exemplary embodiments may further suggest characteristics that may improve expected performance to inform post production and distribution decisions. The characteristics/dimensions upon which the exemplary embodiments may pivot may be quantitative and/or qualitative (e.g., post type, use of social influencers, tonality, video length, thumbnail content, etc.).

### BRIEF DESCRIPTION OF THE DRAWINGS

FIG. 1 shows a system according to the exemplary embodiments.

FIG. 2 shows a comparison server of FIG. 1 according to the exemplary embodiments.

FIG. 3 shows a method of generating a post benchmark of previously used posts according to the exemplary embodiments.

FIG. 4 shows a method of determining a prediction of a post based on post benchmarks according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, system, and method for determining a post benchmark based on previously used posts and utilizing the post benchmark as a basis to determine a projection for a proposed post. Specifically, a previously used or past post having a known result may have information associated therewith such that the known result may be averaged with other known results of other previously used posts having similar information. Thus, in a first aspect, the exemplary embodiments provide a first mechanism in which the post benchmark is generated and maintained for previously used posts. In a second aspect, the exemplary embodiments provide a second mechanism in which the post benchmarks are used to generate the projection for the proposed post.

As will be used herein, a producer may be an entity that creates or has ownership to media content. A distributor may be an entity that distributes the media content to various outlets (e.g., a licensee of the media content). The media content may be any type of content (e.g., pre-recorded shows, live shows, sporting shows, awards shows, etc.) using any type of medium for distribution (e.g., television, cable, satellite, fiber, Internet, etc.). The producer and the distributor may be separate entities or may be the same entity. For illustrative purposes, the producer and the distributor are referred herein collectively as the “distributor.” An advertiser may be an entity that sells a product or service and purchases or otherwise agrees to have advertisements of the product/service shown during the media content. A sponsor may be an entity that provides finances to the distributor to release the media content in exchange for a product/service to be advertised during the media content. The advertiser and the sponsor may be separate entities or may be the same entity. For illustrative purposes, the advertiser and the sponsor are referred herein collectively as the “advertiser.” A social networking entity may be a platform upon which a social network of users interact with one another. An influencer may be an entity having a social personality across one or more social networking entities and having a minimum number of followers across these one or more social networking entities.

It is also noted that the exemplary embodiments are described herein with regard to distributors, advertisers, social networking entities, and influencers. However, this universe of entities, particularly associated with media content, is only exemplary. Those skilled in the art will understand that the exemplary embodiments may be modified and/or used with another universe of entities that may collaborate as a combination for a media content post to reach a greatest audience in an effective manner (e.g., so that a greatest percentage of the reached audience tunes to the media content of the post).

The exemplary embodiments provide a post benchmarking and post projecting feature by ingesting, classifying, and analyzing historic post data. By taking a post that has been used and filtering the post for identifying characteristics associated with the post, the first mechanism of the exemplary embodiments may generate or update a benchmark defined by at least one of the characteristics. In this manner, one or more post benchmarks may be maintained. Thereafter, the second mechanism of the exemplary embodiments may analyze a proposed combination of the entities to be used in a post for a media content and have a projection determined based on this historic post data from past performance. Thus, the proposed post for the media content may be compared to previous posts for other media content. As will be described in further detail below, for benchmarks, a post may include information (e.g., metadata/sub-metadata elements) that is recorded along with post performance metrics (e.g., reach, engagements, etc.). In this manner, a post may be scored against benchmarks for posts with similar characteristics. A multivariate approach for multiple characteristics may also be used. For predictions, posts may be drafted for consideration with a set of selected characteristics such that a performance expectation may be output using the benchmarks. Recommendations on which characteristics to change may also be recommended for predicted performance improvements. For example, if the post creator changed the post text tone to ‘humorous,’ a 5% improvement in engagement may be predicted based on the benchmarks.

As those skilled in the art will understand, the post may refer to any posting from a user or organization in an online manner. For example, the post may be on a social networking website. Thus, the post may include a plurality of different information such as a post date, a post author, a post text, a post content, an audience engagement, an audience comment, etc. Accordingly, the information may be used to identify metadata or characteristics of the post. For example, the post date may indicate day, month, year; the post author may refer to a single user, an entity, an advertiser, an influencer, etc.; the post text may have a length, reading level, use of links, use of keywords/hashtags, thematic topics, an emotionality/tone, etc.; the post content may have a content type, a visual/creative direction, an emotionality/tone, etc.; the audience engagement may include a quantity or type; the audience comment(s) may have a quantity, length, emotionality, etc. However, it is noted that the online manner and social networking website are only exemplary and the exemplary embodiments may be implemented for any benchmarking/projecting determination.

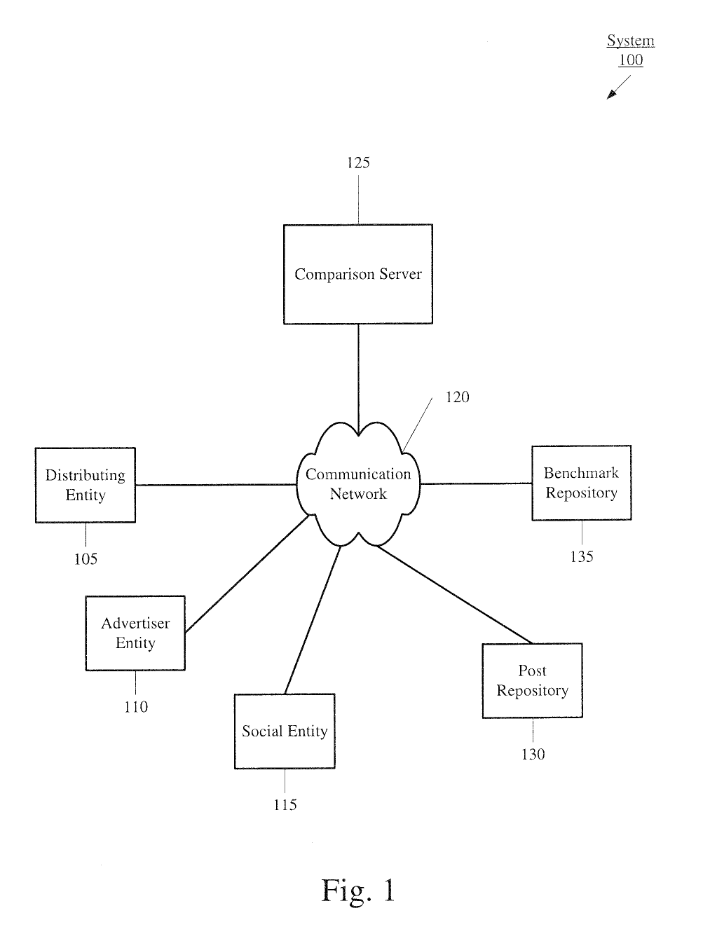

FIG. 1 shows a system 100 according to the exemplary embodiments. The system 100 may include a plurality of entities involved in a media content post. For example, the system 100 may include a distributing entity 105, an advertiser entity 110, and a social entity 115. The system 100 may also include a comparison server 125 configured to generate and maintain post benchmarks as well as determine projections for a proposed post based on the post benchmarks. The distributing entity 105, the advertiser entity 110, the social entity 115, and the comparison server 125 may communicate via a communication network 120. The comparison server 125 may receive data of past posts from a post repository 130 and store post benchmarks in a benchmark repository 135. It should be noted that the system 100 is shown with connections between the components. However, those skilled in the art will understand that these connections may be through a wired connection, a wireless connection, interactions between integrated components or software subroutines, or a combination thereof.

The distributing entity 105 may include a producer and/or distributor who creates or broadcasts, respectively, media content to an audience. The distributing entity 105 may be for media content broadcast using a variety of different mediums. In a first example, the distributing system 105 may broadcast media content using different distribution models (e.g., linear distribution model, a non-linear distribution model, etc.). In another example, the distributing entity 105 may broadcast media content for viewing on television. In a further example, the distributing entity 105 may broadcast media content in an online manner. The media content of the distributing entity 105 may be pre-recorded media content, live media content, on-demand media content, etc. Those skilled in the art will understand that the distributing entity 105 may include various hardware and/or software configured to provide the media content. The distributing entity 105 may also include a server or other communication components to provide data to the comparison server 125. In a specific example, the distributing entity 105 may transmit a request to the comparison server 125 for a projection of a combination of entities to be used in a post for a selected media content.

The advertiser entity 110 may include an advertiser who creates advertisement content that may be shown or included in a media content (e.g., as a sponsorship of the media content). The advertiser entity 110 may be configured to transmit the advertisement content or sponsorship logos to he included in the media content to the distributing entity 105. Those skilled in the art will understand that, like the distributing entity 105, the advertiser entity 110 may include various hardware and/or software configured to provide the advertisement content. The advertisement system 110 may also include a server or other communication components to provide data to the comparison server 125. In a specific example, the advertisement system 110 may also transmit a request to the comparison server 125 for a projection of a combination of entities to be used in a post for a selected media content.

The social entity 115 may include an influencer and/or a social networking entity. The social networking entity may be any online service where users may create a user profile and through connections between users, topics, media content, etc. create a social network. The influencer may be one of these users of the social networking entity who has established an online presence with some minimum number of followers. Furthermore, the influencer may be a user of at least one further social networking entity under the same identity. Therefore, the influencer may have a presence across one or more social networking entities with a minimum number of followers across all these social networking entities. The influencer may also be a celebrity entity who may not have a presence on the social networking entity but has information associated therewith regarding a popularity or follower statistics.

It is noted that the system 100 of FIG. 1 showing a single distributing entity 105, a single advertiser entity 110, and a single social entity 115 is only exemplary. Those skilled in the art will understand that there may be any number of distributing entities who create/distribute various different types of media content. Those skilled in the art will also understand that there may be any number of advertiser entities who create advertisements for various different types of products with some advertiser entities creating advertisements for a plurality of products. Those skilled in the art will further understand that there may be any number of social entities including one or more social networking entities, one or more influencers, or a combination thereof. Thus, the distributing entity 105 may represent all the different sources from which media content originates or is distributed, the advertiser entity 110 may represent all the different sources from which advertisement content is provided, and the social entity 115 may represent all the different social networking entities and/or influencers.

The communications network 120 may be any type of network that enables data to be transmitted from a first device to a second device where the devices may be a network device and/or an edge device that has established a connection to the communications network 120. For example, the communications network 120 may be a cable provider network, a satellite network, a terrestrial antenna network, the public Internet, a local area network (LAN), a wide area network (WAN), a virtual LAN (VLAN), a Wi-Fi network, a cellular network, a cloud network, a wired form of these networks, a wireless form of these networks, a combined wired/wireless form of these networks, etc. The communications network 120 may also represent one or more networks that are configured to connect to one another to enable the data to be exchanged among the components of the system 100. The communications network 120 may also include network components (not shown) that are configured to perform further functionalities in addition to providing a conduit to exchange data.

The post repository 130 may be any source from which data associated with past posts may be received. For example, any of the entities 105, 110, 115 may have collaborated in a post that was used to promote a media content. After the post was used (e.g., a past post), information of the post may be gathered (e.g., by the entities or by third parties). For example, prior to the post being used, the entities involved in the post may already be known as well as the selected media content for which the post is used. Accordingly, various keywords or characteristics of the post (e.g., based on the entities, the media content, etc.) may be determined. In another example, after the post was used, the results from using the post may be determined. Specifically, a reach of the post to unique users, a number of times the post was viewed, etc. may be determined. The sources from which the information of the post is determined may transmit the past post data for storage in the post repository 130.

It is noted that the system 100 of FIG. 1 showing a single post repository 130 is only exemplary. Those skilled in the art will understand that there may be any number of post repositories. For example, the post repositories may be a network of repositories that are utilized based on a parameter (e.g., type of media content, identity of an entity such as the distributing entity 105, etc.). Thus, past posts involving the parameter may be stored in a first post repository while past posts involving a different parameter may be stored in a second post repository.

The benchmark repository 135 may be any source from which generated post benchmarks may be received. As will be described in detail below, the comparison server 125 may generate one or more post benchmarks based on past posts. The post benchmarks may include past posts that have a predetermined minimum of one or more similar characteristics. The post benchmarks may also associate the results of these similar past posts. The results may be averaged, scaled, etc. to indicate how a past post performed.

It is noted that the system 100 of FIG. 1 showing a single benchmark repository 135 is only exemplary. Those skilled in the art will understand that there may be any number of benchmark repositories. For example, in a substantially similar manner as the post repository 130, the benchmark repositories may be a network of repositories that are utilized based on a parameter (e.g., type of media content, identity of an entity such as the distributing entity 105, etc.). Thus, post benchmarks involving the parameter may be stored in a first benchmark repository while post benchmarks involving a different parameter may be stored in a second post repository.

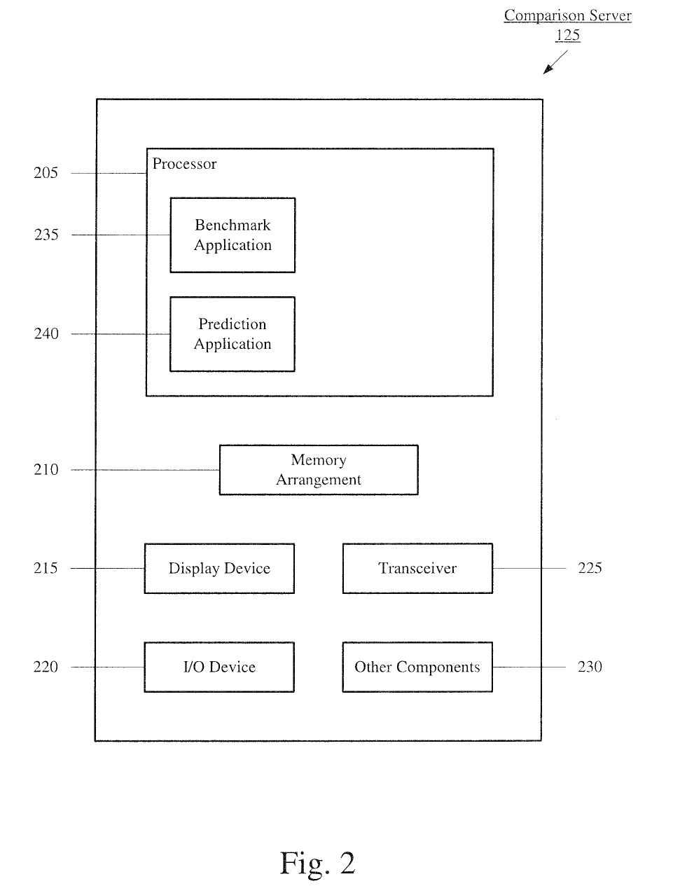

According to the exemplary embodiments, the comparison server 125 may perform a variety of different operations to perform the first mechanism (e.g., generating post benchmarks) and second mechanism (e.g., generating a prediction for a proposed post) of the exemplary embodiments. FIG. 2 shows the comparison server 125 of FIG. 1 according to the exemplary embodiments. The comparison server 125 may include a processor 205, a memory arrangement 210, a display device 215, an input/output (I/O) device 220, a transceiver 225, and other components 230 (e.g., an audio input device, an audio output device, a battery, a data acquisition device, ports to electrically connect to other electronic devices, etc.).

Initially, it is noted that the comparison server 125 being shown as a separate component from the components of the system 100 is only exemplary. For example, in the system 100, the comparison server 125 may provide a service as a third party and receive a request from any of the entities 105, 110, 115. In another example, the functionalities of the comparison server 125 may be incorporated into one of the entities 105, 110, 115. In a particular exemplary embodiment, the distributing entity 105 may include the functionalities of the comparison server 125. As the distributing entity 105 may plan various media content posts for the various media content that is created/distributed, each of these posts may individually utilize a combination of advertiser and social entity.

The processor 205 may be configured to execute a plurality of applications of the comparison server 125. For example, the processor 205 may execute a benchmark application 235 and a prediction application 240. As will be described in further detail below, the benchmark application 235 may be utilized for the first mechanism of the exemplary embodiments. In which past posts are analyzed to generate a post benchmark having associated result information. The prediction application 240 may be utilized for the second mechanism of the exemplary embodiments in which a request including a proposed post for a media content is analyzed to determine a projection based on post benchmarks.

It should be noted that the above noted applications being an application (e.g., a program) executed by the processor 205 is only exemplary. The functionality associated with the applications may also be represented as a separate incorporated component of the comparison server 125 or may be a modular component coupled to the comparison server 125, e.g., an integrated circuit with or without firmware. In yet another example, the functionality associated with the applications may be embodied in a multi-application service or gateway. In a particular manner, the functionalities may be a background operation such that a request for a proposed post may be input, the functionalities may be performed, and an outcome based on the results of the functionalities may be provided. Accordingly, a user may log into the service, input the request, and be provided the outcome (while the functionalities are utilized in a background capacity).

The memory arrangement 210 may be a hardware component configured to store data related to operations performed by the comparison server 125. Specifically, the memory arrangement 210 may store the data from a request, the post repository 130, and the benchmark repository 135. The display device 215 may be a hardware component configured to show data to a user while the I/O device 220 may be a hardware component that enables the user to enter inputs. The transceiver 225 may be a hardware component configured to transmit and/or receive data in a wired or wireless manner. Specifically, the transceiver 225 may be used with the communications network 120.

According to the exemplary embodiments, rather than focusing on the individual entities themselves, the post and the combination of entities along with the selected media content in which the post is used may form a basis to predict how future posts will perform. The exemplary embodiments create deep metadata taxonomies that enable post performance to be benchmarked to predict future performance for posts with similar characteristics. In this manner, the exemplary embodiments ingest posts and enrich the posts with metadata (as stored or determined from the data in the post repository 130). Specifically, the metadata may include explicit post metadata (e.g., pulled from post application program interfaces (APIs)), machine learning characters (e.g., image processing to extract information such as a scene and characters), vendor supplied metadata (e.g., commenter emotionality), enriched metadata (e.g., tone, social talent budget, etc.), etc. Once a post benchmark is characterized, a predictive model may be created to anticipate reach and/or engagement for future posts with similar characteristics.

The exemplary embodiments utilize a more granular approach by predicting a projection of a proposed post using post characteristics from a high level (e.g., overarching theme) to a low level (e.g., minute details extracted from an image). For example, information such as a time of a post, an airing time of the media content, content used in the post, post tone, etc., may provide further insight of a post in characterization such that a comparison of a proposed post having a similar characterization may be determined to have a similar result. Through a blend of machine learning and/or manual enrichment, the models generating a projection may provide a more accurate and higher probability prediction.

As will be described in further detail below, the benchmark application 235 may be utilized for the first mechanism of the exemplary embodiments in which past posts are analyzed to generate a post benchmark having associated result information. The benchmark application 235 may receive data from the post repository 130 of past posts. The benchmark application 235 may utilize the data as a social listening toolset to investigate the performance of the past post around various facets. Through insights into performance of individual posts, a post benchmark may be generated representing past posts having a common minimum similarity to one other. The benchmark application 235 may utilize various modeling and similarity operations to accumulate past posts into a post benchmark. For example, the benchmark application 235 may utilize generalized linear models, logistic regression, multiple linear regression, Bayesian probabilistic models, neural networks, etc.

The benchmark application 235 may initially receive past post data from the post repository 130. The information of the past post may be categorized and classified. For example, keywords or characteristics of the entities involved in the post and the media content for which the post was used may be categorized and classified. The benchmark application 235 may additionally generate metadata to include in the information of the past post. The metadata may be generated from other aspects of the post. For example, the metadata may be a call-to-action, a branding time point, an emotionality/tonality associated with the post, a duration of the post, a time of the post, a type of post, a paid versus organic type of post, a sustained engagement metric, etc. As noted above, this metadata may be explicit (such as the time aspects which may be determined from time stamps) while other metadata may be determined (e.g., emotionality is determined from reactions of users of a social networking entity). Accordingly, the post may further be characterized by this metadata which is categorized and classified.

This enriched and fused post data may be aggregated. Specifically, a first past post having a first set of characteristics may be identified to be substantially similar to one or more second past posts. For example, the first past post and the second past posts may have a minimum number of characteristics in common. Accordingly, the first past post may be included with the second past posts. Characteristics of the first past post that are not in common with the characteristics of the second past posts may also be considered for inclusion in the group to further identify this group of past posts. In this manner, a past post may be grouped with other past posts.

According to another exemplary embodiment, a post benchmark stored in the benchmark repository 135 may be identified as having similar characteristics as a past post. For example, again, a first past post may have a first set of characteristics. The post benchmark may be identified with a second set of characteristics. The first and second characteristics may be used to determine a nexus of commonality between the first past post and the post benchmark. If a predetermined minimum amount of commonality is determined, the first past post may be included in the post benchmark. In this manner, the past post may be grouped with all other past posts used in generating the post benchmark.

Once the benchmark application 235 has grouped a past post with other past posts or with a post benchmark, the results of the past post to be incorporated may be aggregated with the results of the other past posts or the post benchmark. For example, each of the other past posts may individually have associated result information. To determine how this group of past posts (including the past post and the other past posts) performed overall, the results of all the past posts may be aggregated, averaged, scaled, etc. In another example, a post benchmark may have an aggregated result associated therewith. The result of the past post to be incorporated may be incorporated into the aggregated result for update. In this manner, the past post may be utilized to generate a post benchmark with other past posts or update an already existing post benchmark. The post benchmark may then be stored or updated in the post repository 130.

It is noted that the inclusion or incorporation of the past post and its associated information into other past posts or with a post benchmark may be based on a discretion of the benchmark application 235. For example, the past post may have had an outlier result (e.g., reach was significantly too low or too high). In such a scenario, the benchmark application 235 may select to omit the past post from updating the post repository 130.

It is also noted that if the past post has no other similar past posts or no post benchmark having the minimum required commonality, the benchmark application 235 may create a new post benchmark that includes the past post. However, the benchmark application 235 may be configured to only allow post benchmarks to be utilized when a minimum number of past posts have been used as the basis of generating the post benchmark. Thus, until the post benchmark has other past posts incorporated therein, this newly created post benchmark may be stored, maintained, and updated until available for use. In another example, the benchmark application 235 may not create a post benchmark for the past post. Instead, the past post may be stored as a non-benchmark type but in a substantially similar manner as a post benchmark (e.g., with all characteristics associated therewith). Thus, subsequent past posts that are substantially similar to the past post in the non-benchmark type may be included. When the minimum number of past posts have been included, the non-benchmark type may be converted into a post benchmark for use by the prediction application 240.

The benchmark application 235 may perform its operations at a variety of times. In a first example, the benchmark application 235 may continuously monitor the post repository 130 for new information. Accordingly, the operations may be performed upon detecting any new information. In a second example, the benchmark application 235 may perform its operations at predetermined or dynamic time intervals. Thus, the benchmark application 235 may request any new data (e.g., by providing a time stamp of when data was last received) from the post repository 130.

The prediction application 240 may be utilized for the second mechanism of the exemplary embodiments in which a request including a proposed post for a media content is analyzed to determine a projection based on post benchmarks. The prediction application 240 may receive a request of a proposed post. For example, the distributing entity 105 may have an upcoming media content that will be broadcast. In preparation, the distributing entity 105 may consider how best to reach a greatest audience in notifying them of the upcoming media content. Accordingly, the distributing entity 105 may have prepared a set of entities that will collaborate in a campaign or post for the upcoming media content. For example, the distributing entity 105 may include a social networking entity in which the post is to be viewed, a brand of the distributing entity 105 (e.g., a television channel), a social networking influencer, a call-to-action, a duration of the post, a branding time-point, a post tonality (e.g., comedy, serious, etc.), a post day, a post time, etc. The distributing entity 105 may package a request including the entities and the upcoming media content (as well as any other information) to the comparison server 125.

Upon receiving the request, the prediction application 240 may determine characteristics of the proposed post based on explicit characteristics (e.g., identities of the entities, information included in the request, etc.). The prediction application 240 may also include a functionality substantially similar to the benchmark application 240 in which metadata or other information of the proposed post may be determined based on implicit information. Accordingly, further characteristics of the proposed post may be determined.

Based on the characteristics that are identified for the proposed post, the prediction application 240 may reference the benchmark repository 135 to determine if there is at least one post benchmark that satisfies a minimum commonality requirement. For example, the prediction application 240 may determine a similarity index between the proposed post and the post benchmark such that the minimum commonality requirement is being at least a predetermined minimum similarity index. When one or more post benchmarks are identified, the prediction application 240 may determine how the results of the post benchmark or past posts used to generate the post benchmark may determine a projection for the proposed post.

According to a specific exemplary embodiment, the prediction application 240 may utilize the following:

ρ(y|X, β, σ²) ∝ (σ²)^{-n/2} exp (−1/2σ² (y−Xβ)^{T} (y−Xβ))

The exemplified formula may represent a model that is used to estimate a relative performance of a post that requires benchmarking. The Bayesian probabilistic framework of this formula captures linear (as shown here) or non-linear dependencies based on a choice of the model as determined by a user (e.g., an expert). Here, Y is the dependent variable and X and B are the independent variable and the associated learned coefficients and sigma denotes the related variances. By determining how the results of the past posts in the post benchmark are applied to the proposed post, the prediction application 240 may determine a projection for the proposed post. For example, the characteristics of the proposed post (e.g., call-to-action, branding time, emotionality/tonality, duration, post time, post type, etc.) may be compared to the characteristics of past posts of the post benchmark for a learning feature to weight via machine learning (e.g., learning regression, linear regression, Bayesian probabilistic models, etc.) the results of the past posts to determine the projection of the proposed post.

The prediction application 240 may output the results of the projection. For example, the proposed post in the request may have a projection individually shown. Specifically, the projection may include a plurality of different types of projected performances that are listed. The different types o projected performance may include organic views, organic engagement, viral views, viral engagement, etc. The projection may also include an overall projected performance based on the different individual types of projected performances. The overall projected performance may compensate for any overlap among the different individual types of projected performances.

It is noted that the above description relates to when the request includes only a single proposed post. However, the use of the single proposed post in the request is only exemplary. According to another exemplary embodiment, the request may include a proposed campaign that includes one or more proposed posts to be used for a selected media content. Each proposed post may have its own individual characteristics. For example, the proposed posts in the proposed campaign may all be directed to a selected media content. Thus, the proposed posts in the proposed campaign may all have common characteristics when related to the media content on which the post will be used. However, the respective medium on which the proposed posts may be used may differ (e.g., television spots, online advertisements, social networking promotion, etc.). Therefore, the above second mechanism by the prediction application 240 may first be used for each proposed pest in the proposed campaign on an individual basis.

When the request includes a proposed campaign with a plurality of proposed posts, the prediction application 240 may generate the results of the projection for each proposed post and for the proposed campaign. For example, each of the proposed posts in the proposed campaign included in the request may have a projection individually shown. In a substantially similar manner described above, the projection may include a plurality of different types of projected performances that are listed. Again, the projection for each proposed post may also include an overall projected performance based on the different individual types of projected performances (with compensation for any overlap). In another example, a projected performance for the proposed campaign may be shown. The prediction application 240 may be configured to combine the results of each proposed post into a projected performance for the proposed campaign. Again, the prediction application 240 may compensate for any overlap of the results from each proposed post so that the projected performance for the proposed campaign is not skewed. In a further example, the output from the prediction application 240 may include both the results of each proposed post and the result of the proposed campaign.

If the post benchmark being used for the proposed post (or campaign) is based on a number of past posts that are under a predetermined minimum (e.g., to qualify for use by the prediction application 240), the prediction application 240 may return an output that a projection may not be currently available. However, the prediction application 240 may be configured with an option to still provide the output using the manner described above. When the prediction application 240 determines the projection in this way, the output may include a disclaimer indicating that the post benchmark that was used is based on only a certain number of past posts. In fact, the output may include the number of past posts or a confidence value in the output. It is noted that the number of past posts or the confidence value may be utilized regardless of this scenario occurring or not. The prediction application 240 may also include a feature for a response to be provided should this scenario arise. Specifically, if the post benchmark being used is based on a number of past posts that are under the predetermined minimum, the prediction application 240 may transmit a request for a manual confirmation to continue given this set of circumstances.

The prediction application 240 may be configured with further features. For example, the prediction application 240 may include a suggestion functionality. The suggestion functionality may enable the prediction application 240 to counter the proposed post with a suggestion to potentially improve the projection. During the process of determining the projection for the proposed post given the characteristics correlating to the proposed post, the prediction application 240 may also determine whether there are any post benchmarks that may not be used for the proposed post (e.g., based on the characteristics) but fall within a next category of similarity. For example, while calculating similarity indexes for the post benchmarks in the benchmark repository 135, the prediction application 240 may determine whether any of the post benchmarks have a similarity index that is less than a first threshold (used to identify post benchmarks to be used with the proposed post) but greater than a second threshold (used to identify post benchmarks for consideration of a suggestion). The prediction application 240 may review the results of these secondary post benchmarks that have a similarity index satisfying this condition. When the results of these secondary post benchmarks are better than the projection for the proposed post, the prediction application 240 may determine which aspect of the proposed post that may be changed to improve the projection based on the aspects of the secondary post benchmarks. For example, the time in which the proposed post may air may be suggested to be changed to improve the projected reach based on a time associated with a secondary post benchmark. Thus, the prediction application 240 may further output a suggestion and a projection based on this suggestion.

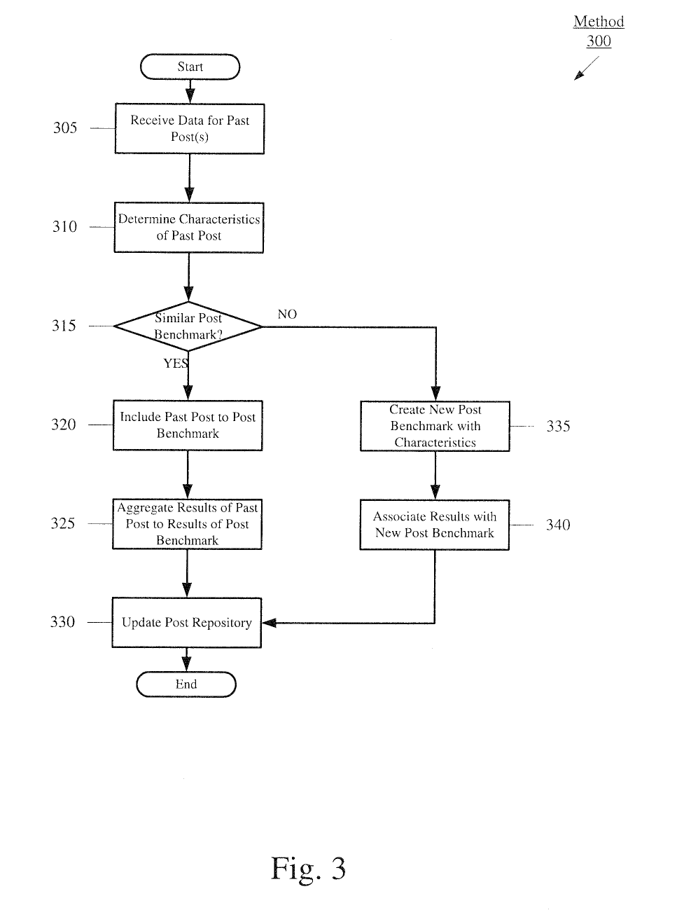

FIG. 3 shows a method 300 of generating a post benchmark of previously used posts according to the exemplary embodiments. The method 300 relates to the process by which the comparison server 125 receives past post data to update a post benchmark or create a post benchmark. The method 300 will be described from a perspective of the benchmark application 235 of the comparison server 125. The method 300 will be described with regard to the system 100 of FIG. 1 and the comparison server 125 of FIG. 2.

In 305, the comparison server 125 receives data for one or more past posts. As described above, data of past posts may be stored in the post repository 130. Also described above, the comparison server 125 may perform the first mechanism of the exemplary embodiments at a variety of times. In a first example, the benchmark application 235 may monitor when data for a past post has been stored in the post repository 130. In this manner, the comparison server 125 may request and receive data for a past post. In a second example, the benchmark application 235 may perform the first mechanism at a predetermined time interval (e.g., hourly, daily, weekly, etc.). Thus, data for one or more past posts that have been stored during this time interval may be requested and received.

In 310, the comparison server 125 selects a past post and determines characteristics of the past post. As described above, various operations may be used to determine the characteristics of the past post. For example, explicit characteristics may be determined based on the media content for which the past post was used, the entities involved in the past post, etc. The comparison server 125 may also determine or request other characteristics. These other characteristics may be metadata including a call-to-action, a duration, a branding time-point, a post emotionality/tonality, a post day, a post time, retention analysis, etc.

In 315, the comparison server 125 may determine whether there are any similar post benchmarks in the benchmark repository 135. The post benchmarks stored in the benchmark repository 135 may have characteristics that are associated therewith. Accordingly, a similarity index may be determined between the characteristics of the past post to the characteristics of the post benchmarks. If the similarity index between the past post and a select post benchmark is greater than a predetermined threshold, the past post may be determined to belong to the select post benchmark.

When the similarity index is greater than the predetermined threshold, in 320, the comparison server 125 includes the past post in the post benchmark. The inclusion of the past post in the post benchmark may incorporate the characteristics of the past post that do not overlap with the post benchmark to be associated in some manner. In 325, the comparison server 125 aggregates the results of the past post with the results associated with the post benchmark. In this manner, the results of a more recent past post may be reflected in the post benchmark. Thus, in 330, the comparison server 125 updates the post repository 130 with a post benchmark incorporating the past post.

Returning to 315, when the similarity index is less than the predetermined threshold, in 335, the comparison server 125 creates a new post benchmark having the characteristics of the past post. In 340, the comparison server 125 associates the results of the past post with the new post benchmark. Thus, in 330, the comparison server updates the post repository 330 by including a new post benchmark.

It is noted that the process described with the method 300 is only exemplary. The above description of the method 300 has several assumptions. In a first example, an assumption includes always creating a new post benchmark if no similar post benchmarks are identified in 315. However, the method 300 may be modified such that a new post benchmark is not always created. Instead, the method 300 may include operations to create a non-benchmark type or check for non-benchmark types that are similar to the past post. The non-benchmark type may ensure that post benchmarks that are available for use are only created and maintained when a minimum number of past posts are used as a basis. Accordingly, the method 300 may include another operation to determine whether a non-benchmark type is to be converted to a post benchmark. In a second example, the method 300 may utilize a flag or other indication to restrict a post benchmark from being used. Specifically, when a post benchmark is based on a number of past posts that do not satisfy a predetermined minimum, the post benchmark may be prevented from being used or indicated as possibly being inaccurate for purposes of determining a projection. In this manner, the method 300 may be modified to incorporate the features described above for the first mechanism of the exemplary embodiments.

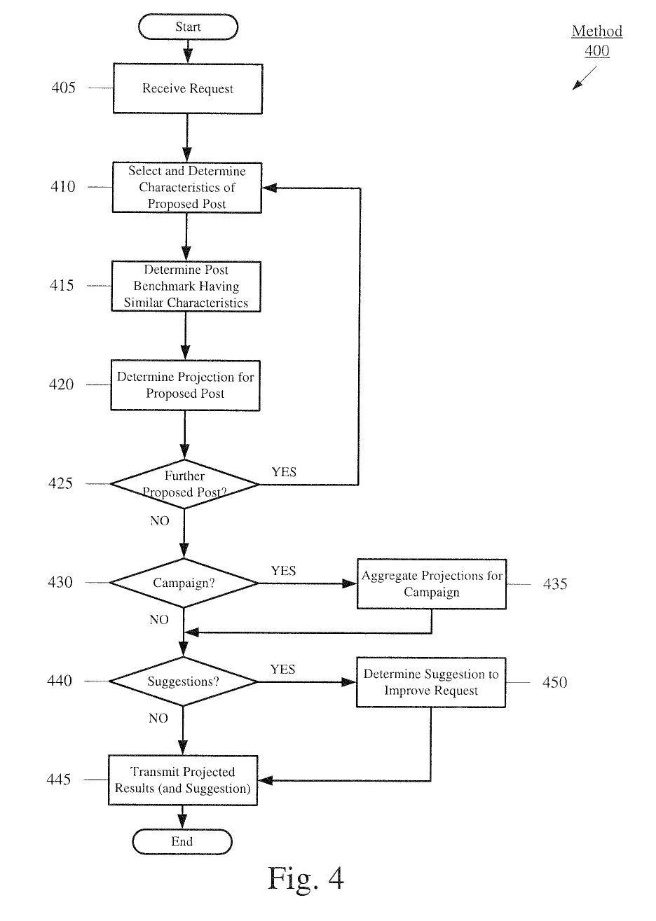

FIG. 4 shows a method 400 of determining a prediction of a post based on post benchmarks according to the exemplary embodiments. The method 400 relates to the process by which the comparison server 125 receives a request to determine a projection based on post benchmarks. The method 400 will be described from a perspective of the prediction application 240 of the comparison server 125. The method 400 will be described with regard to the system 100 of FIG. 1 and the comparison server 125 of FIG. 2.

In 405, the comparison server 125 receives a request. For example, the request may be received from the distributing entity 105, the advertiser entity 110, the social entity 115, a combination thereof, etc. The request may include various types of information. For example, the request may indicate the entities involved in a proposed post. In another example, the request may include characteristics to be considered in a projection. The request may include one or more proposed posts. For example, the request may include a single proposed post. In another example, the request may be a proposed campaign including one or more proposed posts. The proposed campaign may be for a common aspect such as a media content to be promoted by the proposed campaign.

In 410, the comparison server 125 selects and determines characteristics of a proposed post included in the request. As described above, the characteristics may be determined in a variety of manners. For example, the operations described above for 310 of method 300 may be utilized by the prediction application 240 in a substantially similar manner. The proposed post may also include information corresponding to the metadata. For example, on a user interface upon which information for a proposed post is entered, there may be fields corresponding to the types of metadata information.

In 415, the comparison server 125 determines a post benchmark having similar characteristics. As described above, a similarity index may be determined between the characteristics of the past post and the characteristics of the post benchmarks. For example, the operations described above for 315 of method 300 may be utilized by the prediction application 240 in a substantially similar manner.

In 420, the comparison server 125 determines a projection for the proposed post. The comparison server 125 may utilize the results of the post benchmark as a basis of determining the projection for the proposed post. For example, a degree of similarity (e.g., as based on the similarity index) may be used to determine how the results associated with the post benchmark translate to the projection for the proposed post.

In 425, the comparison server 125 determines whether there is at least one more proposed post in the request. As noted above, the request may be a single proposed post or may be a proposed campaign which may include further proposed posts. If there is at least one further proposed post, the comparison server 125 returns to 410. These operations may continue until all proposed posts included in the request have been processed and a respective projection for each of these proposed posts have been determined.

In 430, the comparison server 125 determines whether the request includes a proposed campaign. Although the request may include a plurality of proposed posts, it is not necessarily linked to one another as a campaign. If there is a plurality of proposed posts and they are linked in a proposed campaign, in 435, the comparison server 125 aggregates the projections or otherwise determines a projection for the proposed campaign based on the projections of the individual proposed posts.

In 440, the comparison server 125 determines whether there are any suggestions to improve the proposed post or the proposed campaign. As described above, the prediction application 240 may determine the similarity index between the characteristics of the proposed post and the post benchmarks. When the similarity index is above a first threshold, the post benchmark may be used in determining the projection. However, when the similarity index is below the first threshold but above a second threshold, the post benchmark may be a secondary post benchmark used as a consideration for a suggestion. Specifically, if the secondary post benchmark has associated results that are better than the projection, the secondary post benchmark may provide a basis to determine a suggestion. If these conditions are present, in 450, the comparison server 125 determines a suggestion to improve the request.

In 445, the comparison server 125 generates and transmits the projection and any suggestions to the requesting entity. As described above, the output from the comparison server 125 may provide various aspects of the projections. In a first example, the output may include an organic view projection, an organic engagement projection, a viral view projection, a viral engagement projection, etc. In a second example, the output may include an overall projection that combines the different projection types (with compensation for any overlap). In a third example, the output may include the individual proposed posts and/or the proposed campaign. In a third example, the output may include the suggestions and how use of the suggestion changes the projection.

It is noted that the process described with the method 300 is only exemplary. The above description of the method 300 has several assumptions. In a first example, an assumption includes always identifying a similar post benchmark in 415. However, the method 400 may be modified such that when no similar post benchmarks are identified, an indication that no sufficient projection may be determined may be provided. In a second example, the method 400 may incorporate when non-benchmark types are included in the post repository 130 or when a post benchmark is generated based on a number of past posts that does not satisfy a predetermined minimum. Specifically, the output may indicate the number of past posts that were used in determining the projection or include a disclaimer when the predetermined minimum is not reached. In this manner, the method 400 may be modified to incorporate the features described above for the second mechanism of the exemplary embodiments.

The exemplary embodiments provide a device, system, and method for generating/updating a post benchmark and utilizing post benchmarks to determine a projection for a proposed post. According to a first mechanism of the exemplary embodiments, a post benchmark may be generated based on one or more past posts having known results. Accordingly, the post benchmark may have a set of characteristics associated therewith and also have an aggregate result associated therewith. According to a second mechanism of the exemplary embodiments, proposed post to be used may be analyzed to determine characteristics associated therewith, the associated characteristics being used to identify a post benchmark. The identified post benchmark may serve as a basis to determine a projection for the proposed post using the aggregated result of the post benchmark.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system such as Microsoft Windows, a Mac platform and MAC OS, a mobile device having an operating system such as iOS or Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
at a comparison server:
receiving data of a past post, the past post having been used for a media content, the past post having known results of reaching an audience;
determining at least one first characteristic of the past post based on at least one entity involved in the past post and the media content;
determining a first similarity index of the at least one first characteristic to at least one second characteristic of a post benchmark, the post benchmark having aggregated results associated therewith; and
when the similarity index is above a first threshold, incorporating the past post with the post benchmark, the known results being aggregated with the aggregated results.

2. The method of claim 1, wherein the at least one characteristic includes one of explicit characteristics or metadata characteristics.

3. The method of claim 2, wherein the explicit characteristics are keywords associated with identities of the at least one entity and the media content.

4. The method of claim 3, wherein the entity is one of a distributing entity, a producing entity, an advertiser entity, a sponsor entity, a social networking entity, or an influencer entity.

5. The method of claim 2, wherein the metadata characteristics include information of a manner in which the past post was used.

6. The method of claim 5, wherein the metadata characteristics are at least one of a call-to-action, a branding time-point, an emotionality, a tonality, a duration, a post time, a post day, a post type, a paid versus organic type, a sustained engagement metric, post content, or a retention metric.

7. The method of claim 1, wherein the post benchmark is based on at least one further past post.

8. The method of claim 7, wherein a number of the at least one further past post is greater than a predetermined minimum.

9. The method of claim 1, further comprising:
generating the post benchmark when the determined similarity index is below the first threshold, the aggregated results of the post benchmark corresponding to the known results of the past post, the at least one second characteristic corresponding to the at least one first characteristic of the past post.

10. The method of claim 1, further comprising:
identifying one of the at least one first characteristic exclusive to the at least one second characteristic; and
determining whether to include the identified one of the at least one first characteristic into the at least one second characteristic of the post benchmark.

11. The method of claim 1, further comprising:
receiving a request including at least one proposed post, the proposed post to be used for a further media content, the proposed post indicating at least one entity to be involved in the proposed post, the request including metadata characteristics indicative of a manner in which the proposed post is to be used;
determining at least one third characteristic of the proposed post based on the at least one entity to be involved in the proposed post and the further media content;
determining a second similarity index of the at least one third characteristic to the at least one second characteristic of the post benchmark; and
when the second similarity index is above the first threshold, generating a first projection of reaching the audience based on the aggregated results of the post benchmark.

12. The method of claim 11, wherein the request includes a proposed campaign including the proposed post and at least one further proposed post.

13. The method of claim 12, further comprising:
for each of the further proposed post:
determining at least one fourth characteristic of the further proposed post based on at least one entity to be involved in the further proposed post and the further media content;
determining a third similarity index of the at least one fourth characteristic to the at least one second characteristic of the post benchmark; and
when the third similarity index is above the first threshold, generating a second projection of reaching the audience based on the aggregated results of the post benchmark.

14. The method of claim 13, further comprising:
aggregating the first projection and the second projection into an overall projection for the proposed campaign.

15. The method of claim 14, wherein the first projection and the second projection are aggregated into the overall projection by compensating for an overlap between the first proposed post and the second proposed post.

16. The method of claim 1, wherein the past post is used as a part of a media content campaign to promote the media content prior to a broadcast of the media content.

17. A comparison server, comprising:
a transceiver receiving data of a past post, the past post having been used for a media content, the past post having known results of reaching an audience; and
a processor determining at least one first characteristic of the past post based on at least one entity involved in the past post and the media content, the processor determining a first similarity index of the at least one first characteristic to at least one second characteristic of a post benchmark, the post benchmark having aggregated results associated therewith, when the similarity index is above a first threshold, the processor incorporating the past post with the post benchmark, the known results being aggregated with the aggregated results.

18. A method, comprising:
at a comparison server:
receiving a request including a proposed post, the proposed post to be used to promote a media content, the proposed post indicating at least one entity to be involved in the proposed post, the request including metadata characteristics indicative of a manner in which the proposed post is to be used;
determining at least one first characteristic of the proposed post based on the at least one entity to be involved in the proposed post and the media content;
determining a similarity index of the at least one first characteristic to at least one second characteristic of a post benchmark, the post benchmark having aggregated results associated therewith, the aggregated results indicative of a reach to an audience; and
when the similarity index is above a first threshold, generating a projection of reaching the audience based on the aggregated results of the post benchmark.

19. The method of claim 18, wherein the metadata characteristics are associated with time parameters and timing parameters of the proposed post.

20. The method of claim 18, further comprising:
identifying a further post benchmark having at least one third characteristic, the similarity index of the at least one first characteristic to the at least one third characteristic being less than the first threshold and greater than a second threshold;
determining whether further aggregated results of the further post benchmark have a greater reach than the projection; and
when the further aggregated results has the greater reach, determining a suggestion to improve the proposed post based on the at least one third characteristic of the further post benchmark.
